(19) United States
(12) Patent Application Publication
(10) Pub. No.: US 2012/0000457 A1
(43) Pub. Date: Jan. 5, 2012

(54) Cooking appliance

(75) Inventors: Christophe PAYSANT, La Tour En Jarez (FR); Bruno CURSOUX, Mornant (FR)

(73) Assignee: APPLICATION DES GAZ, Saint Genis Laval (FR)

(21) Appl. No.: 12/826,830

(22) Filed: Jun. 30, 2010

(51) Int. Cl. A47J 37/07; F24C 3/08

(52) U.S. Cl. 126/25 R; 126/39 E

(57) ABSTRACT

This invention relates to a cooking appliance, namely of the gas grill type, comprising a cooking shaft (3), at least one radiant gas burner (4, 5) on the side of the cooking shaft (3), having a radiating surface (6) emitting infrared radiation, adjacent to the cooking shaft, and the orientation of which with respect to the latter has a vertical component, a transverse cooking grid (7) occupying an upper opening of the cooking shaft (3), a bottom (8) extending across the cooking shaft, located under the radiating surface (6) having some permeability to liquids flowing from the grid (7) towards collecting means (22) located under the bottom. The bottom (8) comprises at least one first reflecting inclined solid portion (9, 10) turned towards the radiating surface (6) of a burner (4, 5) and a second pierced lateral area (12, 13) located between the radiating surface (6) of a burner (4, 5) and the first reflecting inclined solid area (9, 10).

This invention relates to a cooking appliance, namely of the gas grill type.

It is known, namely from the document EP 0 713 668, to make a cooking appliance, namely of the gas grill type, comprising:
a cooking shaft,
at least one radiant gas burner on the side of the cooking shaft, having a radiating surface emitting infrared radiation, adjacent to the cooking shaft, and the orientation of which with respect to the latter has a vertical component,
a transverse cooking grid occupying an upper opening of the cooking shaft,
a bottom extending across the cooking shaft, located under the radiating surface having some permeability to liquids flowing from the grid towards collecting means located under the bottom.

This appliance is satisfactory in that it allows for healthier cooking, by avoiding or decreasing carcinogenic flames and smoke, while ensuring proper energetic efficiency.

However, it is desirable to improve the homogeneity of the cooking in an appliance of the before-mentioned type, while preserving proper efficiency and ensuring healthy cooking.

It is an aim of this invention to solve all or part of the above-mentioned shortcomings.

For this purpose, the object of this invention is a cooking appliance according to the before-mentioned type, characterized in that the bottom comprises at least one first reflecting inclined solid portion turned towards the radiating surface of a burner, and a second pierced lateral area located between the radiating surface of a burner and the first reflecting inclined solid area.

In fact, the arrangements according to the invention allow for temperatures to be distributed more evenly over the surface of the grid, while avoiding to create at the surface of the bottom spots of excessive temperature, which might cause ignition of the juice dripping from the grid.

The bottom according to the invention acts like a diffuser of the heat produced by the radiant burners. The reflecting areas will redirect part of the infrared radiations towards the cooking grid, namely at the points of the grid remote from the radiant burners.

Advantageously, the second pierced area is inclined downwards in the direction of the center of the shaft.

According to one embodiment, the upper end of a first solid area is positioned under at least one part of a pierced area.

These arrangements allow for the heating of the first reflecting area remaining under the radiating surface of the burners to be limited, thereby limiting exposure thereof to infrared radiation.

Advantageously, at least one second pierced area or a first solid area comprises at least one groove or rib made in the direction of the slope of this area.

According to one embodiment, the bottom comprises lumens passing therethrough at a connection between a first inclined solid area and a second pierced area.

These arrangements allow for efficient discharging of juice coming from the cooking grid into a position forming a low point of the bottom.

Advantageously, the first reflecting solid area is inclined with respect to the plane of the cooking grid by an angle comprised between 10 and 50°.

According to one embodiment, the first reflecting solid area is inclined with respect to the plane of the cooking grid by an angle comprised between 20 and 30°.

According to one embodiment, the appliance comprises two gas burners located on either side of the cooking shaft, and wherein the bottom comprises two first reflecting inclined planar areas, respectively turned towards the two radiating surfaces of the two burners, and two second pierced lateral areas, each located between a burner and the two first areas.

The invention will be better understood by means of the detailed description which is given below with reference to the appended drawing, in which:

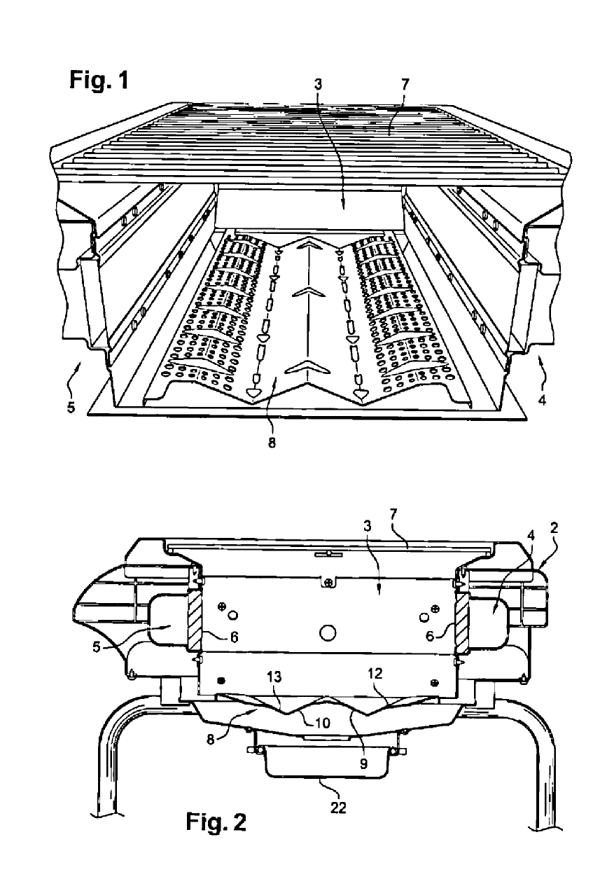

FIG. 1 is a perspective view of a portion of a cooking appliance, with one portion of the cooking shaft being removed;

FIG. 2 is a sectional view of the cooking appliance of FIG. 1;

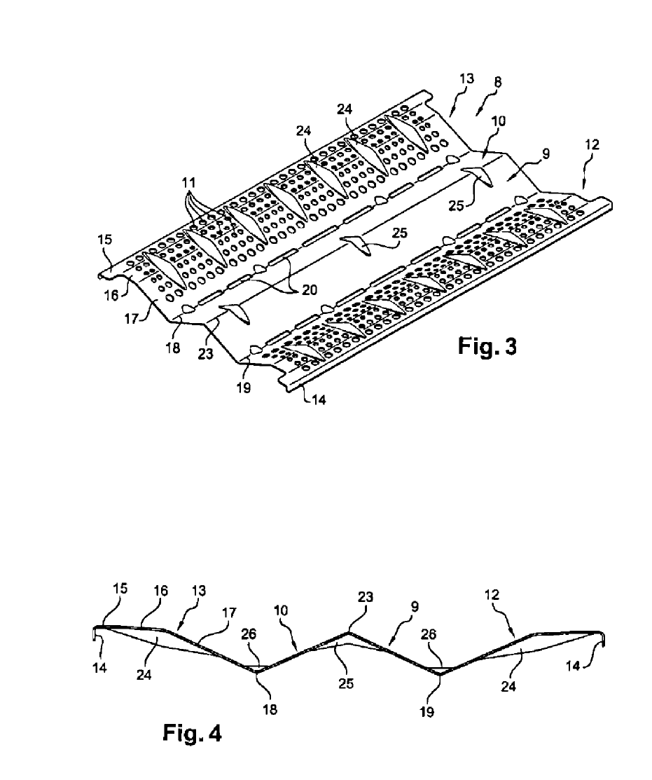

FIG. 3 is a perspective view of the bottom of the cooking appliance of FIG. 1;

FIG. 4 is a sectional view of the bottom of the cooking appliance of FIG. 1.

As represented in FIGS. 1 and 2, a cooking appliance according to the invention, according to an embodiment of the gas grill type, comprises a frame 2 defining a cooking shaft 3.

Inside the frame, two radiant gas burners 4, 5 are housed, located on either side of the cooking shaft 3. Each radiant gas burner 4, 5 has a radiating surface 6, emitting infrared radiation, adjacent to the cooking shaft 3. The radiating surface is substantially vertical.

A transverse cooking grid 7 occupies an upper opening of the cooking shaft 3.

A bottom 8 extends across the cooking shaft 3, under the radiating surface 6 of the burners 4, 5. The bottom 8 comprises two first reflecting inclined planar areas 9, 10 respectively turned towards the two radiating surfaces of the two burners 4, 5. These two first areas are adjacent by their uppermost edge. The bottom 8 also comprises two second pierced lateral areas 12, 13 each located between a burner 4, 5 and the first two areas 9, 10.

Each first reflecting solid area 9, 10 is inclined with respect to the plane of the cooking grid by an angle on the order of 25°.

According to variants, the angle may be comprised between 10 and 50°, and preferably between 20 and 30°.

Each pierced area comprises a plurality of through holes 11 allowing to decrease the surface exposed to the radiation of the radiant burners. These arrangements allow for heating of these areas intended to be close to the burners to be limited and prevent them from exceeding the ignition temperature of the cooking juice, which can be estimated at about 280°.

The second pierced areas 12, 13 are inclined downwards in the direction of the center of the shaft. Each second pierced area 12, 13 comprises a fastening flange 14 on an external edge thereof, intended to cooperate with complementary fastening means of the frame 2.

Each pierced area 12, 13 comprises three differently inclined adjacent portions 15, 16, 17. In particular, the pierced area comprises a first planar portion 15, a second portion 16 having an inclination towards the center of the plate, and a third portion 17 having an inclination greater than that of the second portion 16 towards the center of the plate.

In the embodiment represented in the figures, the inclination of the second portion 16 is on the order of 4° with respect to the horizontal line, and of 25° pour the third portion 17.

The connections 18, 19 between the first inclined solid areas 9, 10 and the second pierced areas 12, 13 comprise lumens 20 passing through the plate and allowing for juice coming from the cooking grid 7 to flow out towards a collecting vessel 22, and thus some permeability to liquids flowing from the grid 7.

The upper end 23 of the two first solid areas is positioned or substantially at the same level as the lateral parts 15 of the pierced areas.

The solid areas 9, 10 and the pierced areas 12, 13 comprise grooves 24, 25 made in the direction of the slope of this area, the bottom of which is also inclined so as to allow for the juice to flow out.

Reinforcing ribs 26 are provided at the connecting areas 18, 19 between the solid areas 9, 10 and pierced areas 12, 13.

In the represented embodiment, the bottom 8 is advantageously composed of a metal plate.

Although the invention has been described in relation to specific sample embodiments, it is obvious that it is not limited in any way thereby, and that it comprises all equivalent techniques of the means described, as well as the combinations thereof, if they fall into the scope of the invention.

1. A cooking appliance, namely of the gas grill type, comprising:
a cooking shaft (3),
at least one radiant gas burner (4, 5) on the side of the cooking shaft (3), having a radiating surface (6) emitting infrared radiation, adjacent to the cooking shaft, and the orientation of which with respect to the latter has a vertical component,
a transverse cooking grid (7) occupying an upper opening of the cooking shaft (3),
a bottom (8) extending across the cooking shaft, located under the radiating surface (6) having some permeability to liquids flowing from the grid (7) towards collecting means (22) located under the bottom,
characterized in that
the bottom (8) comprises at least one first reflecting inclined solid portion (9, 10) turned towards the radiating surface (6) of a burner (4, 5), and a second pierced lateral area (12, 13) located between the radiating surface (6) of a burner (4, 5) and the first reflecting inclined solid area (9, 10).

2. The appliance according to claim 1, wherein the second pierced area (12, 13) is inclined downwards in the direction of the center of the shaft (3).

3. The appliance according to any of the preceding claims, wherein the upper end (23) of a first solid area (9, 10) is positioned under at least one part of a pierced area (12, 13).

4. The appliance according to any of the preceding claims, wherein the bottom (8) comprises lumens (20) passing therethrough at a connection (18, 19) between a first inclined solid area (9, 10) and a second pierced area (12, 13).

5. The appliance according to any of the preceding claims, wherein at least one second pierced area (12, 13) or a first solid area (9, 10) comprises at least one groove (24, 25) or rib made in the direction of the slope of this area.

6. The appliance according to any of the preceding claims, wherein the first reflecting solid area (9, 10) is inclined with respect to the plane of the cooking grid (7) by an angle comprised between 10 and 50°.

7. The appliance according to claim 6, wherein the first reflecting solid area (9, 10) is inclined with respect to the plane of the cooking grid (7) by an angle comprised between 20 and 30°.

8. The appliance according to any of the preceding claims, comprising two gas burners (4, 5) located on either side of the cooking shaft, and wherein the bottom comprises two first reflecting inclined planar areas (9, 10) respectively turned towards the two radiating surfaces (6) of the two burners (4, 5), and two second pierced lateral areas (12, 13) each located between a burner and the two first areas.
